(19) United States
(12) Patent Application Publication
(10) Pub. No.: US 2012/0126562 A1
(43) Pub. Date: May 24, 2012

(54) MODULAR EXTENSION PLATE KIT FOR LIFTGATES

(75) Inventors: Karapet Ablabutyan, Glendale, CA (US); Akop Gasparian, Panorama City, CA (US)

(73) Assignee: RS DRAWINGS, LLC, Santa Fe Springs, CA (US)

(21) Appl. No.: 13/387,701

(22) PCT Filed: Jul. 27, 2010
(86) PCT No.: PCT/US10/43441

§ 371 Date: Jan. 27, 2012

Related U.S. Application Data
(60) Provisional application No. 61/229,200, filed on Jul. 28, 2009.

(51) Int. Cl. B62D 33/08; B23P 11/00

(52) U.S. Cl. 296/26.08; 29/428

(57) ABSTRACT

The present invention provides a modular extension device and method for mounting the modular extension device on a vehicle, such as a truck. The modular extension plate device comprises an extension plate, a left extender bracket, and potentially a right extender bracket, that when coupled together form an extension assembly. The extension plate further comprises an elongated rectangular plate having an essentially L-shaped profile, a left substantially triangle-shaped support member, a right substantially triangle-shaped support member, a left essentially L-shaped support member and a right essentially L-shaped support member. The modular extension assembly can be coupled adjacent to the rear edge of a vehicle bed for extending the depth of the vehicle bed.

### CROSS REFERENCE TO RELATED APPLICATIONS

This application claims priority to U.S. Provisional Patent Application Ser. No. 61/229,200 filed Jul. 28, 2009, incorporated herein by reference in its entirety.

### BACKGROUND OF THE INVENTION

1. Field of the Invention

The present invention relates generally to liftgates, and in particular, to an extension plate for a liftgate system.

2. Description of Related Art

Lifts such as liftgates are typically mounted at a structure, such as the rear of a vehicle, to lift payloads on a platform from one level (e.g., ground level) up to another level (e.g., the bed of the vehicle), or vice versa.

One type of liftgate employs linkages to maintain the lift platform in a horizontal plane throughout the lifting range. The lift platform is attached to linkages by pivot members, which allow the lift platform to be pivoted. Operation of the lifting mechanism may also rotate the lift platform into an inverted, stowed position beneath the vehicle body. Hydraulic actuators and electric actuators are used to provide lifting force for moving the lift.

### BRIEF SUMMARY OF THE INVENTION

The present invention provides a modular extension plate kit and method for mounting the modular extension plate kit on a vehicle, such as a truck. In one embodiment, the modular extension plate kit comprises an extension plate, and one or more extender brackets configured for coupling to the ends of the extension plate to form an extension assembly essentially matching the width of a vehicle bed. The extension plate further comprises an elongated rectangular plate having an essentially L-shaped profile, with two substantially triangle-shaped support members and two essentially L-shaped support members. The substantially triangle-shaped support members and the essentially L-shaped support members are coupled (e.g. welded) to both ends of the elongated rectangular plate. The elongated rectangular plate can be coupled (e.g. removably bolted with nuts and bolts) adjacent to the rear edge of a vehicle bed for extending the depth (reach) of the vehicle bed.

Each extender bracket in the modular extension plate kit comprises two essentially L-shaped parallel support elements and an essentially L-shaped extender plate coupled (e.g. welded) to both support elements. The extender brackets can be coupled (e.g. removably bolted with nuts and bolts) alone or in tandem to the ends of the extension plate to form the extension assembly. The extension assembly may comprise one or more extension brackets coupled to the extension plate, in various combinations, in order that the assembly match the width of a vehicle bed.

The extension assembly may further comprise one or more steps systems capable of coupling to either the extension plate or extension brackets. Each step system comprises at least one step platform providing a means for climbing onto the extension plate.

These and other features, aspects and advantages of the present invention will become understood with reference to the following description, appended claims and accompanying figures.

### BRIEF DESCRIPTION OF THE DRAWINGS

FIG. 1A illustrates a front perspective view of a disassembled modular extension plate kit, according to an embodiment of the present invention.

FIG. 1B illustrates a front perspective view of a modular extension plate assembly, according to an embodiment of the present invention.

FIG. 1C illustrates a rear perspective view of the modular extension plate assembly, according to an embodiment of the present invention.

FIG. 2A illustrates a bottom perspective view of a right extender bracket and a left extender bracket and mounting hardware, according to an embodiment of the present invention.

FIG. 2B illustrates a side perspective view of the left extender bracket, according to an embodiment of the present invention.

FIG. 2C illustrates a top perspective view of the right and left extender brackets, according to an embodiment of the present invention.

FIG. 2D illustrates a bottom perspective view of the extension plate, according to an embodiment of the present invention.

FIG. 2E illustrates a bottom perspective view of an end of the extension plate, according to an embodiment of the present invention.

FIG. 2F illustrates a side view of the extension plate, according to an embodiment of the present invention.

FIG. 2G illustrates a perspective view of the extension plate, according to an embodiment of the present invention.

FIG. 3 illustrates a bottom perspective view of the modular extension plate assembly, according to an embodiment of the present invention.

FIG. 4 illustrates a bottom perspective view of the left extender bracket coupled to the extension plate, according to an embodiment of the present invention.

FIG. 5 illustrates a bottom perspective view of the right extender bracket coupled to the extension plate, according to embodiments of the present invention.

FIG. 6 illustrates a bottom perspective view of the rear edge of a vehicle bed, according to an embodiment of the present invention.

FIG. 7 illustrates a perspective view of the modular extension plate kit coupled to the rear edge of the vehicle bed, according to an embodiment of the present invention.

FIG. 8 illustrates a top view of the modular extension plate assembly coupled to the rear edge of the vehicle bed, according to an embodiment of the present invention.

FIG. 9 illustrates a rear view of the modular extension plate assembly coupled to the rear edge of the vehicle bed, according to an embodiment of the present invention.

FIG. 10 illustrates a bottom view of the modular extension plate assembly coupled to the rear edge of the vehicle bed, according to an embodiment of the present invention.

FIG. 11 illustrates a front perspective view of a modular extension plate assembly, according to an embodiment of the present invention.

FIG. 12 illustrates a bottom perspective view of a modular extension plate assembly, according to an embodiment of the present invention.

FIG. 13 illustrates a bottom perspective view of the second left extender bracket coupled to the first left extender bracket, the first left extender bracket further coupled to the extension plate, according to an embodiment of the present invention.

FIG. 14 illustrates a perspective view of a left and a right step system, according to an embodiment of the present invention.

FIG. 15 illustrates a perspective view of the left and right step system coupled to the modular extension assembly, according to an embodiment of the present invention.

FIG. 16 illustrates a rear perspective view of the left and right step system coupled to the modular extension assembly, according to an embodiment of the present invention.

FIG. 17 illustrates a perspective view of the modular extension plate kit utilizing the left and right step system and coupled to the rear edge of the vehicle, according to an embodiment of the present invention.

FIG. 18 illustrates a bottom perspective view of the modular extension plate kit utilizing the left and right step system and coupled to the rear edge of the vehicle, according to an embodiment of the present invention.

FIG. 19 illustrates a rear view of the modular extension plate kit utilizing the left and right step system and coupled to the rear edge of the vehicle, according to an embodiment of the present invention.

FIG. 20 illustrates a rear perspective view of the modular extension plate assembly utilizing the left and right step system and coupled to the rear edge of the vehicle, according to an embodiment of the present invention.

FIG. 21 illustrates a perspective view of the modular extension plate assembly utilizing the left and right step system and coupled to the rear edge of the vehicle, the vehicle having a liftgate coupled thereto, according to an embodiment of the present invention.

FIG. 22 illustrates a side view of the modular extension plate assembly utilizing the left step system and coupled to the rear edge of the vehicle, the vehicle having a liftgate coupled thereto, according to an embodiment of the present invention.

FIG. 23 illustrates a perspective view of an extension plate coupled to the rear edge of the vehicle, according to an embodiment of the present invention.

FIG. 24 illustrates a side view of the extension plate coupled to the rear edge of a vehicle, according to an embodiment of the present invention.

FIG. 25 illustrates a perspective view of the left and right step systems coupled to the extension plate and the plate coupled to the rear edge of a vehicle, according to an embodiment of the present invention.

FIG. 26 illustrates a side view of the right step system coupled to the extension plate and the plate coupled to the rear edge of a vehicle, according to an embodiment of the present invention.

FIG. 27 illustrates a method for mounting a modular extension plate kit to the rear edge of a vehicle, according to an embodiment of the present invention.

### DETAILED DESCRIPTION OF THE INVENTION

The following description is made for the purpose of illustrating the general principles of the invention and is not meant to limit the inventive concepts claimed herein. Further, particular features described within can be used in combination with other described features in each of the various possible combinations and permutations. Unless otherwise specifically defined herein, all terms should be given their broadest possible interpretation including meanings implied from the specification as well as meanings understood by those skilled in the art and/or as defined in dictionaries, treatises, etc.

The present invention provides a modular extension plate kit and method for mounting the modular extension plate kit on a vehicle, such as a truck. In one embodiment, the modular extension plate kit comprises an extension plate, a left extender bracket, and a right extender bracket. The extension plate comprises an elongated rectangular plate having an essentially L-shaped profile, two substantially triangle-shaped support members, and two essentially L-shaped support members. The substantially triangle-shaped support members and the essentially L-shaped support members are coupled (e.g., welded) to both ends of the elongated rectangular plate. The elongated rectangular plate can be coupled (e.g., removably bolted with nuts and bolts) adjacent to the rear edge of a vehicle bed for extending the depth (reach) of the vehicle bed.

Each extender bracket in the modular extension plate kit comprises two essentially L-shaped parallel support elements and an essentially L-shaped extender plate coupled (e.g., welded) to both support elements. The essentially L-shaped extender plate can be coupled (e.g., removably bolted with nuts and bolts) adjacent to the rear edge of the vehicle bed for extending the depth (reach) of the vehicle bed.

To assemble the modular extension plate kit, the left and right extender brackets are coupled adjacent to both ends of the elongated rectangular plate. Specifically, the innermost L-shaped support element of a given extender bracket is coupled (e.g., bolted) to one triangle-shaped support member and one L-shaped support member of the extension plate. The elongated rectangular plate and both L-shaped extender plates are then coupled adjacent to the rear edge of the vehicle bed and essentially match the vehicle bed width. In another embodiment, only a single extender bracket may be coupled to the extension plate for the modular extension plate kit to match the vehicle bed width.

In another embodiment, more than two extender brackets may be coupled to the extension plate for the modular extension plate kit to match the vehicle bed width. For example, a first left extender bracket, a first right extender bracket, and a second right extender bracket are coupled to the extension plate. Specifically, the innermost L-shaped support element of the second left extender bracket is coupled (e.g., bolted) to the outermost L-shaped support element of the first left extender bracket. The innermost L-shaped support element of the first left extender bracket is further coupled (e.g. bolted) to one triangle-shaped support member and one L-shaped support member of the extension plate. The configuration is similar should more than one right extender bracket be necessary.

In another embodiment of the present invention, the modular extension plate kit comprises an extension plate, at least one extender bracket, and at least one step system. The step system allows an end user to climb up to the vehicle bed and/or the extension plate. Each step system may be coupled (e.g., bolted) to one triangle-shaped support member and one L-shaped support member of the extension plate. Alternatively, the step system may be coupled to the outermost L-shaped support element of an extender bracket.

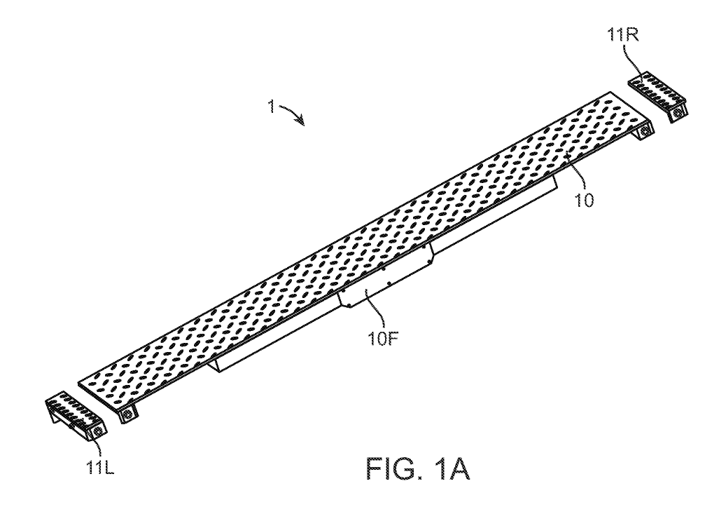

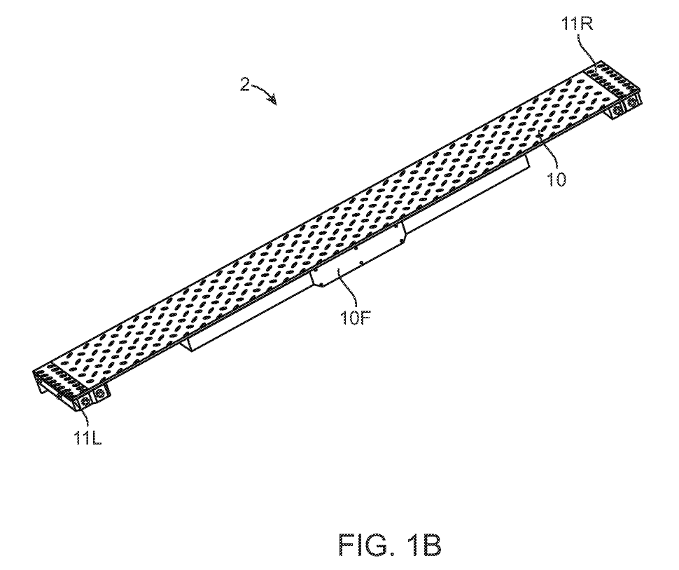

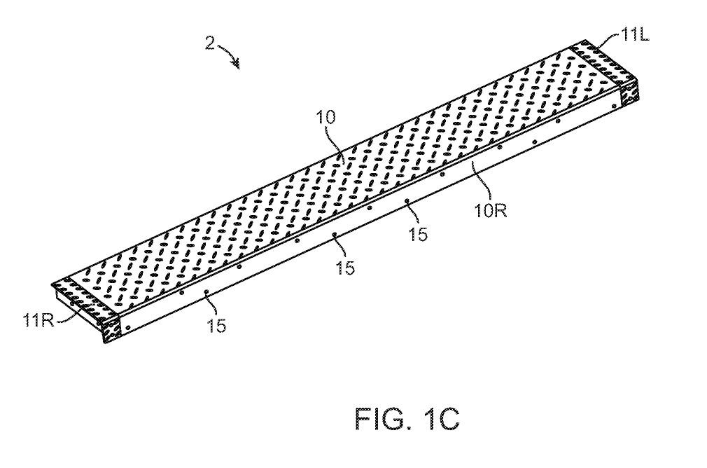

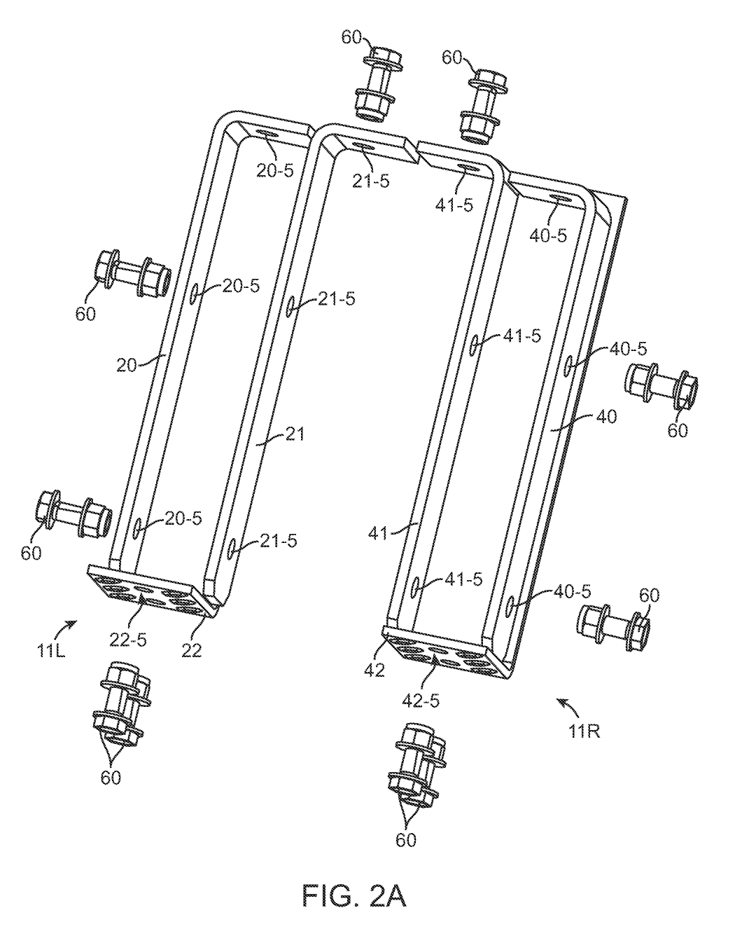

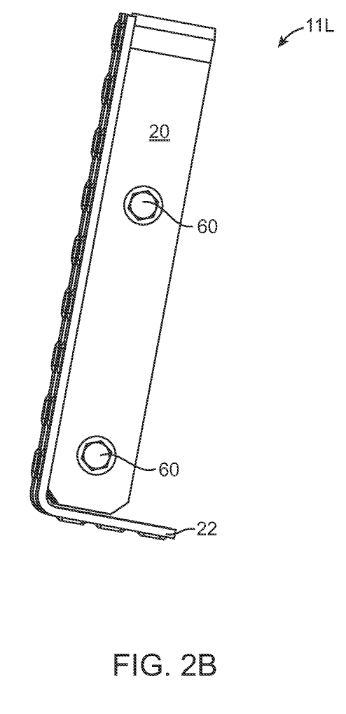

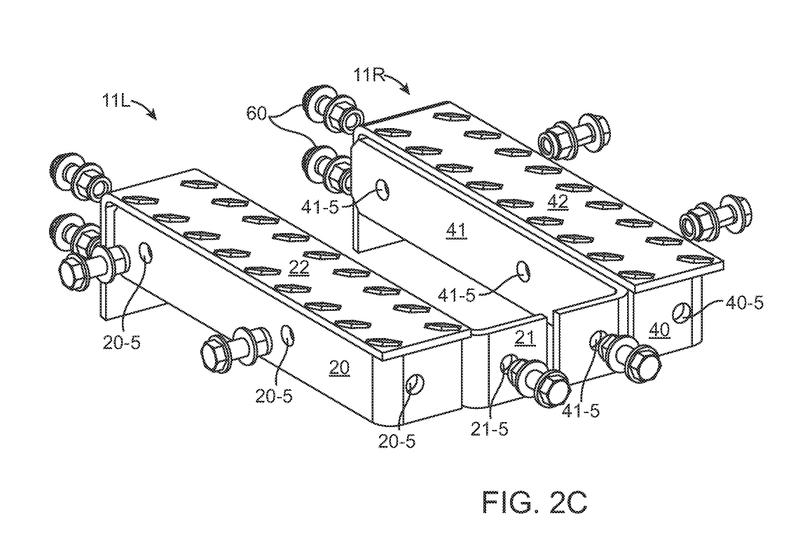

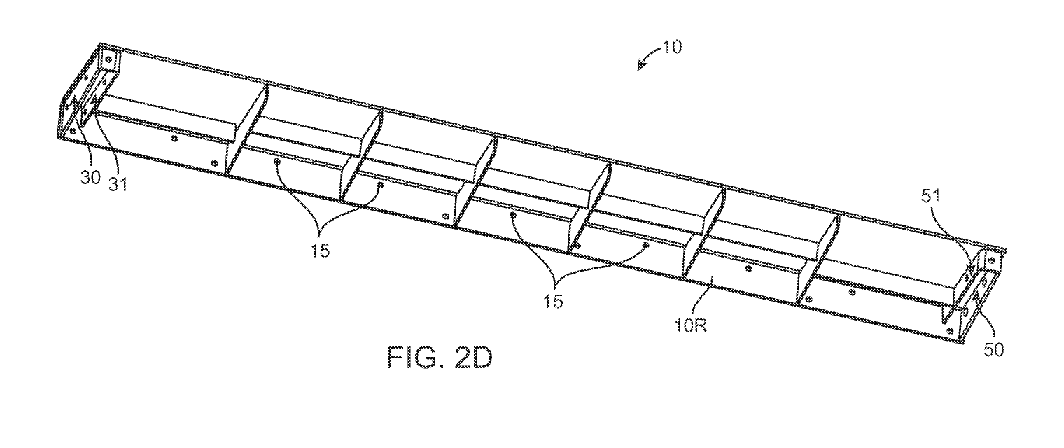

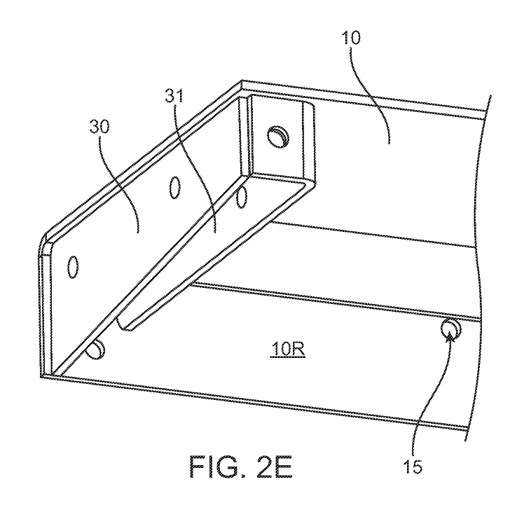

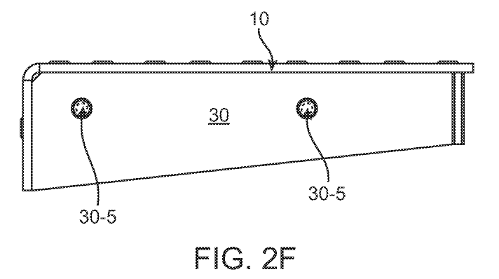

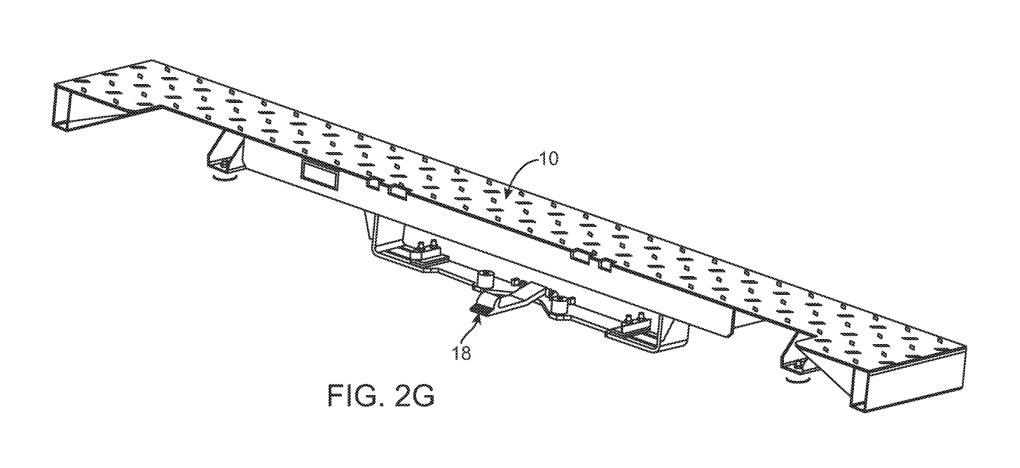

Referring generally to FIGS. 1A-1C and FIGS. 2A-2G, FIG. 1A illustrates a front perspective view of a disassembled modular extension plate kit (i.e., modular extension plate device) 1 including an extension plate 10 and one or more extender brackets (i.e., extender members) 11, according to an embodiment of the present invention. FIG. 1B illustrates the extension plate kit 1 of FIG. 1A wherein two extender brackets 11 (i.e., left extender bracket 11L and left extender bracket 11R) are connected to the left and right ends or edges of the extension plate 10, respectively, forming the modular extension plate assembly 2, according to an embodiment of the present invention. FIG. 1C illustrates a rear perspective view of the assembled modular extension plate assembly 2.

The extension plate 10 comprises an elongated rectangular plate having an essentially L-shaped profile (FIG. 2F). In this embodiment, the modular extension plate assembly 2 has a diamond pattern on its top surface to improve friction and reduce end users slipping off the assembly 2. The modular extension plate kit 1 may optionally further comprise a front member 10F (FIG. 1B) for displaying vehicle information (e.g., license plate). The extension plate 10 further comprises a rear essentially planar member 10R (FIG. 1C) having a plurality of apertures 15 for coupling (e.g., welding, removably bolted with nuts and bolts, etc.) the modular extension plate kit 1 to the rear of a vehicle.

FIG. 2A illustrates a bottom perspective view of the right extender bracket 11R and the left extender bracket 11L and mounting hardware 60, according to an embodiment of the present invention. FIG. 2B illustrates a side perspective view of the left extender bracket 11L, according to an embodiment of the present invention. The left extender bracket 11L comprises two essentially L-shaped parallel support elements 20, 21, and one essentially L-shaped extender plate 22 coupled (e.g., welded) transverse (e.g., perpendicular) to both support elements 20, 21 (FIG. 2A). In one example, each of the support elements 20, 21, comprises an essentially planar rectangular metal plate bent into an L-shape form.

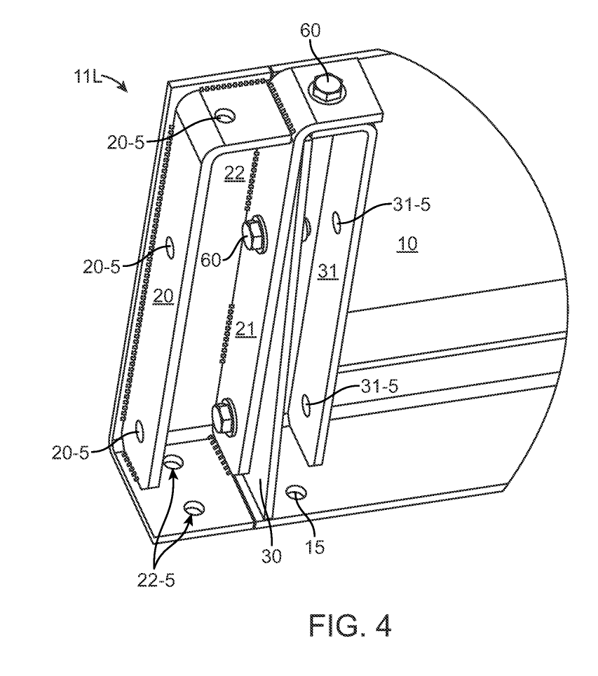

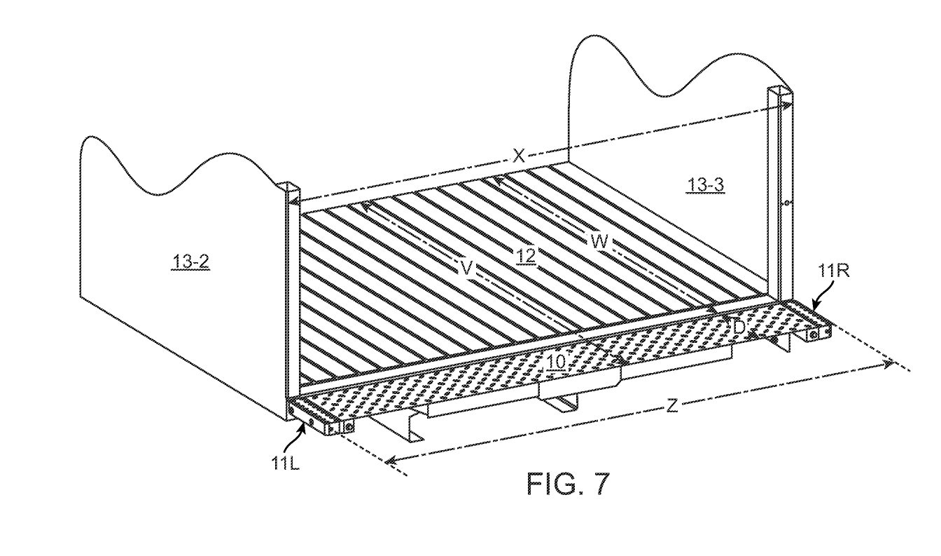

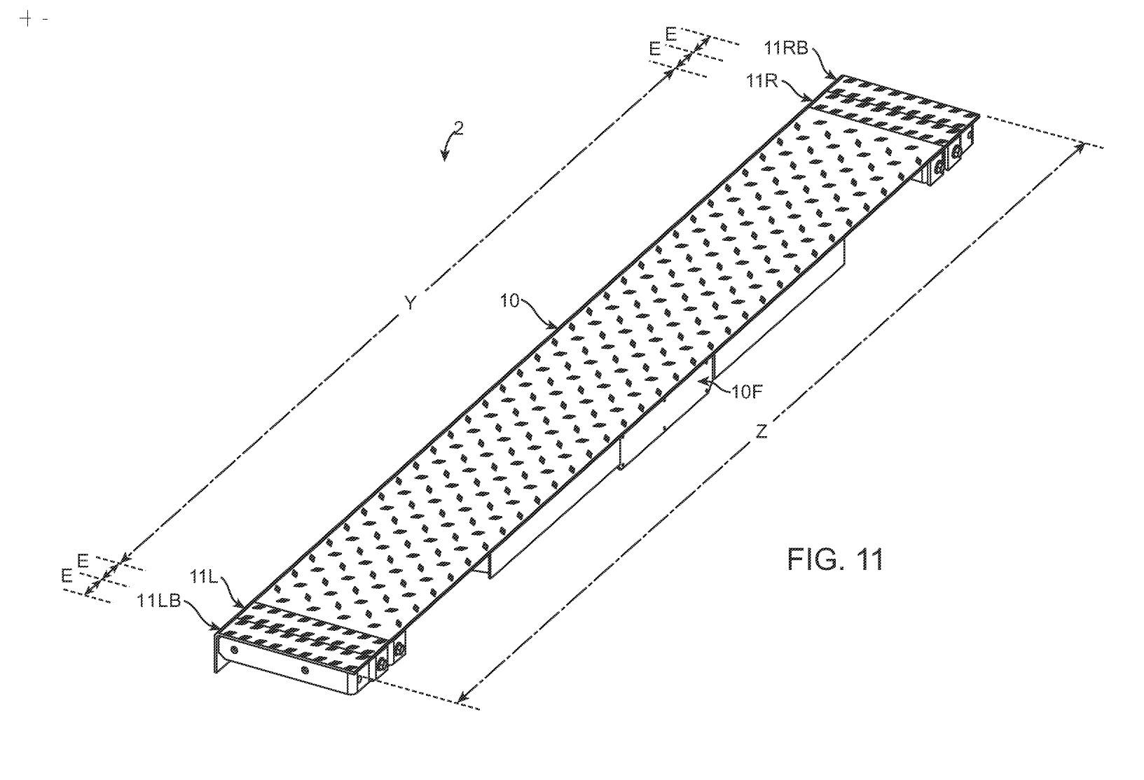

In one embodiment, the innermost support element 21 further comprises three apertures 21-5, two residing on the elongated of the element 21 and one residing on the short portion. The three apertures 21-5 are for coupling the left extender bracket 11L to the end of the extension plate 10 (FIG. 1C). The outermost support element 20 further comprises three apertures 20-5, two residing on the elongated portion of the element 20, and one residing on the short portion thereof. These apertures 20-5 are for coupling a second left extender bracket 11LB to the left extender bracket 11L (FIG. 11), as described further below. The extender plate 22 further comprises two apertures 22-5 residing on the short portion of the plate 22 (FIGS. 1, 4). These apertures 22-5 are for coupling the left extender bracket 11L to the rear of a vehicle, in a similar manner as coupling the extension plate 10 to the rear of the vehicle (FIG. 7), as described further below.

The right extender bracket 11R and the left extender bracket 11L are similar in dimensions and construction and are essentially mirror images of one another. Accordingly, referring to FIGS. 1B-1C and 2A, the right extender bracket 11R comprises two essentially L-shaped parallel support elements 40, 41, and one essentially L-shaped extender plate 42 coupled (e.g., welded) perpendicular to both support elements 40, 41. The innermost support element 41 further comprises three apertures 41-5, two residing on the elongated portion of the element 41 and one residing on the short portion thereof. The three apertures 41-5 are for coupling the right extender bracket 11R to the end of the extension plate 10 (FIG. 1). The outermost support element 40 further comprises three apertures 40-5, two residing on the elongated portion of the element 40 and one residing on the short portion thereof. These apertures 40-5 are for coupling a second right extender bracket 11RB to the right extender bracket 11R (FIG. 11), as described further below. The extender plate 42 further comprises two apertures 42-5 residing on the short portion of the plate 42. The apertures 42-5 are for coupling the right extender bracket 11R to the rear of a vehicle in a similar fashion as coupling the extension plate 10 to the rear of the vehicle (FIG. 7).

In one embodiment of the invention, both the left and right extender brackets 11L, 11R utilize mounting hardware 60 (e.g. nuts and bolts) for coupling the brackets to other elements such as to the extension plate 10, the rear of a vehicle, other extender brackets, etc.

As noted, FIG. 2B illustrates a side perspective view of the left extender bracket 11L, according to an embodiment of the present invention. In this view, it is apparent the extender plate 22 has an essentially L-shaped configuration. The two apertures 22-5 on the elongated portion of the outermost support element 20 are obscured in this view by mounting hardware 60 which are placed into the apertures 22-5. In one embodiment, the mounting hardware 60 comprises nut/bolt elements as shown, for coupling the left extender element 11L to other elements via one or more of apertures 20-5, 21-5, 22-5 of the left extender bracket 11L. The right extender plate may similarly be coupled to other elements.

FIG. 2C illustrates a top perspective view of the right and left extender brackets 11R, 11L, according to an embodiment of the present invention. FIG. 2C shows the left extender bracket 11L comprises said outermost essentially L-shaped support element 20, said innermost essentially L-shaped support element 21, and an essentially L-shaped extender plate 22. The two essentially L-shaped support elements 20 and 21 are assembled (e.g., welded) adjacent and parallel to each other in an “LL” configuration. The extender plate 22 is then coupled (e.g., welded) to a side edge or profile of the assembly of the support elements 20 and 21. As such, the support elements 20 and 21 are essentially perpendicular to the plane of the extender plate 22.

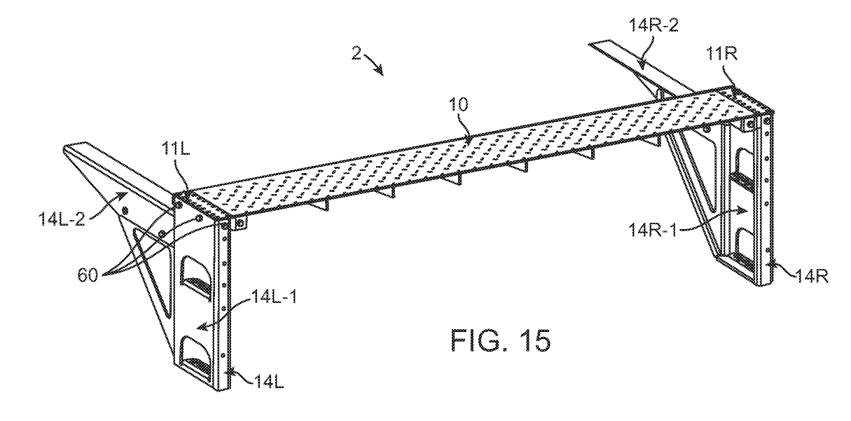

As seen in FIG. 2C, the outermost essentially L-shaped support element 20 contains three apertures 20-5 for coupling to other elements such as a subsequent extender bracket 11LB (FIG. 11), a step system 14L (FIG. 15), etc., via mounting hardware 60 or other mounting means (e.g., welding).

As shown in FIG. 2C, the right extender bracket 11R comprises said outermost essentially L-shaped support element 40, said innermost essentially L-shaped support element 41, and said essentially L-shaped extender plate 42. The two essentially L-shaped support elements 40-41 are coupled (e.g., welded) parallel to each other and further perpendicularly coupled at one side edge to the extender plate 42. The top of the essentially L-shaped extender plate 42 comprises an aluminum diamond pattern to facilitate friction and/or tread. As seen in FIG. 2C, the innermost essentially L-shaped support element 41 contains three apertures 41-5 for coupling to an extension plate 10 (FIG. 1). Similar to the left extender bracket 11L, the right extender bracket 11R utilizes standard sized mounting hardware 60.

FIG. 2D illustrates a bottom perspective view of the extension plate 10, according to an embodiment of the present invention. FIG. 2E illustrates a bottom perspective view of an end of the extension plate 10, according to an embodiment of the present invention. The extension plate 10 comprises an elongated rectangular plate having an essentially L-shaped profile. The rear member 10R of the plate 10 further comprises a plurality of apertures 15 which facilitate coupling the modular extension plate assembly 2 to the rear of a vehicle (FIG. 7). The left most end of extension plate 10 comprises a substantially triangle-shaped support member 30 and an essentially L-shaped support member 31. Similarly, the right most end of the extension plate 10 comprises a substantially triangle-shaped support member 50 and an essentially L-shaped support member 51 (FIG. 2D). The substantially triangle-shaped support members 30, 50, and essentially L-shaped support members 31, 51, are utilized to couple (e.g. bolt) a variety of items: extender brackets 11L, 11R (FIG. 1B), step systems 14L, 14R (FIG. 15), etc., to ends of the extension plate 10.

As shown in FIG. 2E, the substantially triangle-shaped support member 30 is coupled (e.g., welded) to both the long and rear member 10R of the extension plate 10. The support member 30 also resides at the edge of and perpendicular to the plane of the extension plate 10. The essentially L-shaped support member 31 is only coupled (e.g., welded) to the long portion of the extension plate 10; it does not couple to the rear member 10R thereof. The short portion of the essentially L-shaped support member 31 is parallel to the rear member 10R of the extension plate 10, but resides on the opposing side of the long portion of the extension plate 10.

FIG. 2F illustrates a side view of the extension plate 10, according to an embodiment of the present invention. In this view, it is apparent that the extension plate 10 and rear member form an essentially L-shaped profile. It is also apparent in FIG. 2F that the substantially triangle-shaped support member 30 couples to both the long portion and rear member of the extension plate 10. The apertures 30-5 in the triangle-shaped support member 30 allow for the coupling of a variety of items: extender brackets 11L, 11R (FIG. 1B), step systems 14L, 14R (FIG. 15), etc., to ends of the extension plate 10.

FIG. 2G illustrates a perspective view of the extension plate 10, according to an embodiment of the present invention. In this embodiment, an essentially rectangular ramp lock 18 is coupled (e.g., welded) to the underside of the extension plate 10. The ramp lock 18 is designed to secure a rigid metal (e.g., aluminum) loading ramp (not shown) residing parallel to and underneath the vehicle bed. When released from the ramp lock 18, one end of the rigid metal ramp may rest atop the extension plate 10, the other end resting on the ground away from the extension plate, and allow for the loading and/or unloading of materials from the vehicle bed. The ramp lock 18 is further designed so that the secured loading ramp does not interfere with a liftgate and/or liftgate mounting members also residing underneath the vehicle bed.

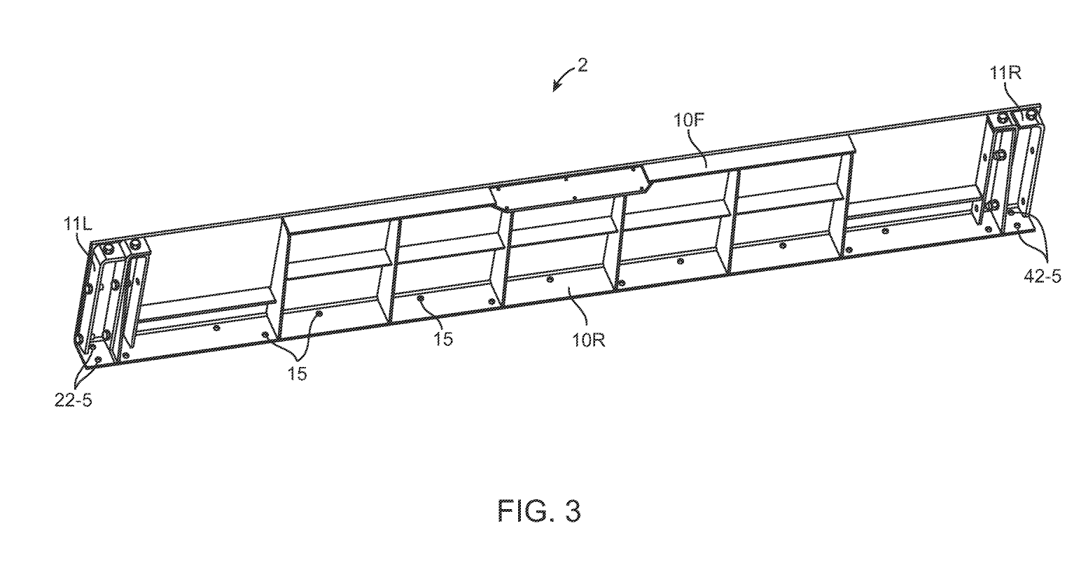

FIG. 3 illustrates a bottom perspective view of the modular extension plate kit 1 in assembled from as modular extension plate assembly 2, according to an embodiment of the present invention. In this view, both the front member 10F and rear member 10R of the extension plate 10 are visible. Also visible are the apertures 22-5 in the left extender bracket 11L as well as the apertures 42-5 in the right extender bracket 11R. These apertures 22-5, 42-5, along with apertures 15 in the extension plate 10 are used for coupling the extension assembly 2 to the rear of a vehicle.

FIG. 4 illustrates a bottom perspective view of the left extender bracket 11L coupled/assembled to the extension plate 10, according to an embodiment of the invention. In this view, the substantially triangle-shaped support member 30 and essentially L-shaped support member 31 of the extension plate 10 are visible. In this configuration, the left extender bracket 11L attaches to the extension plate 10 by coupling (e.g., bolting with mounting hardware 60) the innermost support element 21 to both the triangle-shaped support member 30 and the L-shaped support member 31. The two apertures residing on the elongated portion of support element 21 of the bracket 11L couple to the triangle-shaped support member 30 of the plate 10 by means of mounting hardware 60. The one aperture residing on the short portion of the support element 21 of the bracket 11L couples to the short portion of the support member 31 of the plate 10 by means of mounting hardware 60.

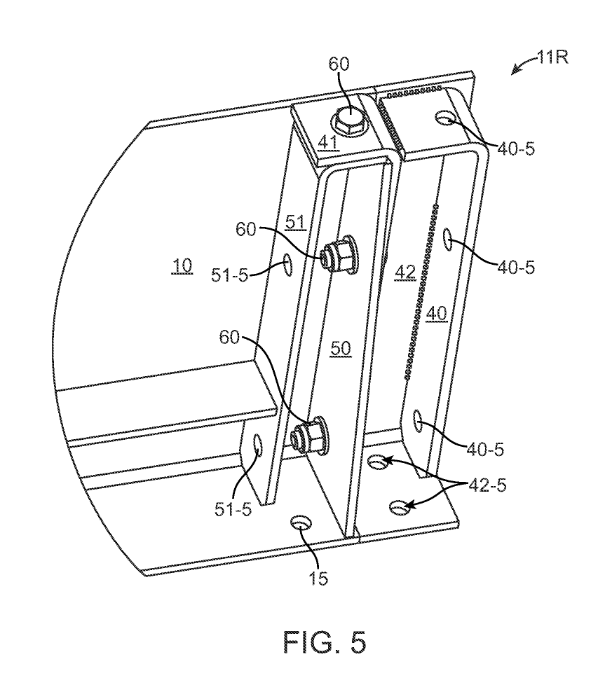

FIG. 5 illustrates a bottom perspective view of the right extender bracket 11R coupled to the extension plate 10, according to embodiments of the present invention. In this view, the substantially triangle-shaped support member 50 and essentially L-shaped support member 51 are also visible. In this configuration, the right extender bracket 11R attaches to the extension plate 10 by coupling (e.g., bolting with mounting hardware 60) the innermost support element 41 to both the triangle-shaped support member 50 and the L-shaped support member 51. The two apertures residing on the elongated portion of support element 41 of the bracket 11R couple to the triangle-shaped support member 50 of the plate 10 by means of mounting hardware 60. The one aperture residing on the short portion of the support element 41 of the bracket 11R couples to the short portion of the support member 51 of the plate 10 by means of mounting hardware 60.

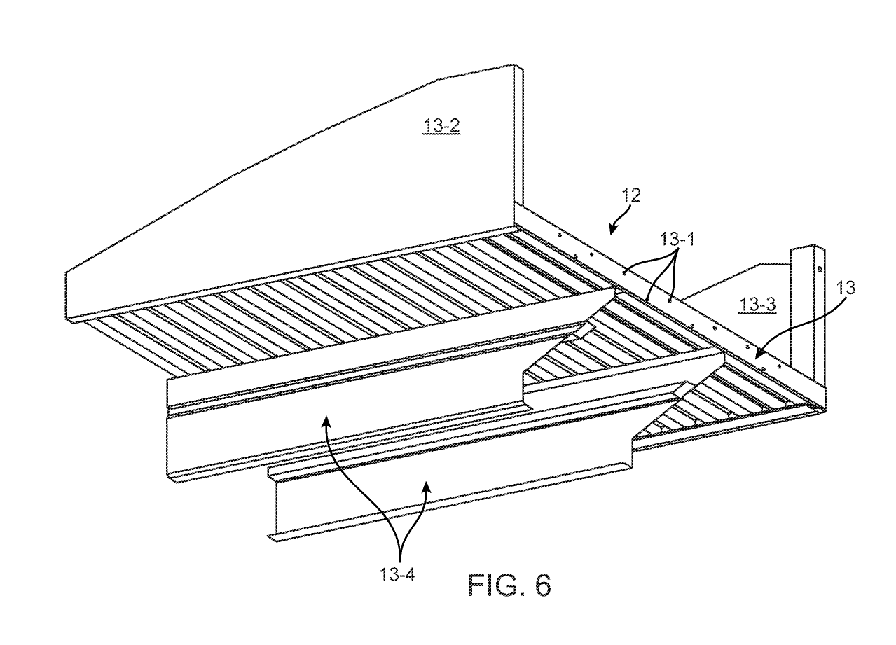

FIG. 6 illustrates a bottom perspective view of a vehicle bed 12 to which the modular extension plate assembly 2 may be coupled, according to an embodiment of the invention. The vehicle bed 12 (e.g., flat bed truck) has a rear edge 13 with plurality of apertures 13-1 for coupling the modular extension plate assembly 2 thereto via the apertures 15 of the plate 10R (FIG. 1C) using mounting hardware 60. FIG. 7 illustrates a perspective view of the modular extension plate assembly 2 coupled to the rear edge 13 of the vehicle bed 12. The extension plate 10 extends (i.e., supplements) the original depth W of the vehicle bed 12 to an extended depth V (FIG. 7) by the depth D of the extension plate 10. In one embodiment of the present invention, the vehicle further comprises a left wall 13-2 and a right wall 13-3 on opposite sides of the vehicle bed 12. The vehicle may also comprise liftgate mounting members 13-4 coupled to the bottom of the vehicle bed 12.

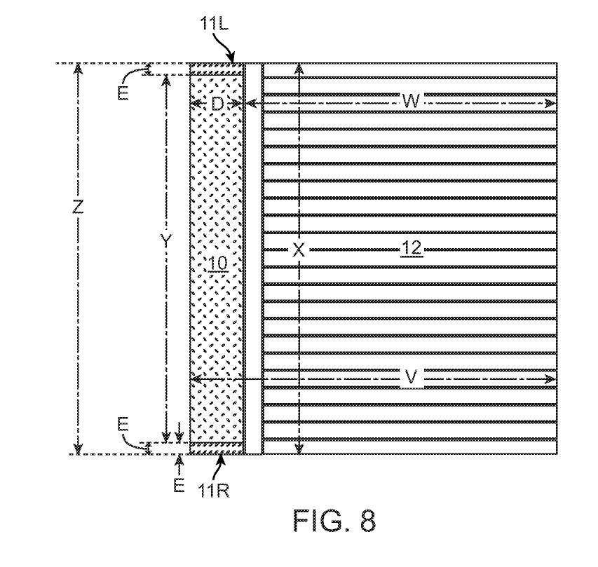

FIG. 7 illustrates a perspective view of the modular extension plate assembly 2 coupled to the rear edge 13 of the vehicle bed 12, according to an embodiment of the present invention. FIG. 8 illustrates a top view of the modular extension plate assembly 2 coupled to the rear edge 13 of the vehicle bed 12, according to an embodiment of the present invention. As shown in FIGS. 7-8, the vehicle bed 12 has a width X which is the distance between the left and right walls 13-2, 13-3. The vehicle bed 12 also has a depth W which is the distance between the front and rear of the bed. The modular extension plate assembly 2 comprising the extension plate 10, left extender bracket 11L, and right extender bracket 11R, has a width Z which is the distance between the left and right extender brackets 11L, 11R. As depicted in FIG. 7, the modular extension plate assembly 2 has a width Z which equals the width X of the vehicle bed 12. When the modular extension plate assembly 2 is coupled to the rear edge of the vehicle bed 12, the depth V of the vehicle bed 12 and assembly 2 is greater than the depth W of the bed 12 alone, wherein V=W+D.

As shown by example in FIG. 8, the width X of the vehicle bed 12 is greater than the width Y of the extension plate 10. Inconsistent bed and extension plate widths produce gaps at the outermost edges of the combination (plate 10 coupled to bed 12). Items and/or personnel on the vehicle bed 12 may occupy these gap(s) and fall to the ground below. However, utilizing one or more extender brackets 11L, 11R with the extension plate 10 as needed, supplements the width Y of the extension plate modular extension plate assembly 2 by the width E of each extender bracket, to essentially match the width X of the vehicle bed 12. Also visible in FIG. 8 is how the depth V of the vehicle bed 12 extends beyond the normal bed depth W when the modular extension plate assembly 2 is employed, wherein the width X is about the same as the extended width Z=Y+E+E. Further, the extended depth V=W+D.

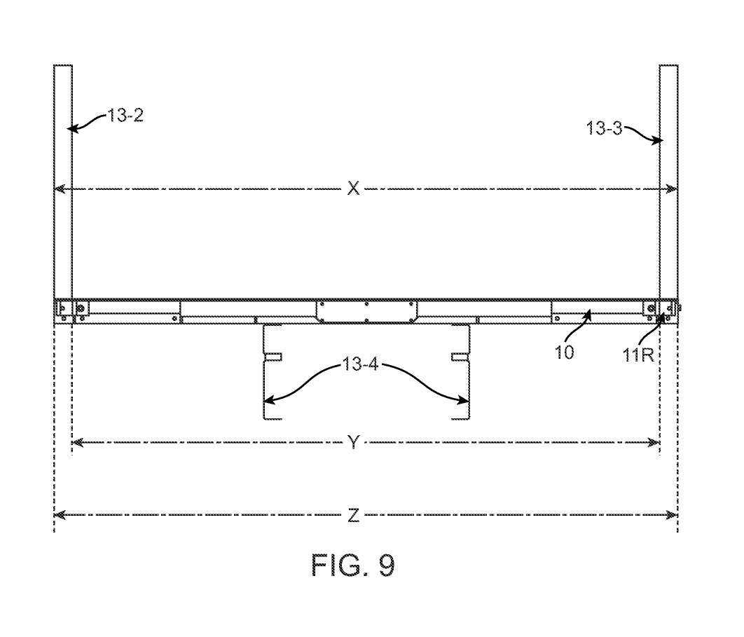

FIG. 9 illustrates a rear view of the modular extension plate assembly 2 coupled to the rear edge 13 of the vehicle bed 12 (corresponding to FIGS. 7-8), according to an embodiment of the present invention. In this view, it is apparent the width X of the vehicle bed is the distance between the left wall 13-2 and right wall 13-3. It is also apparent the width Y of the extension plate 10 alone is less than the vehicle bed width X. However, by employing the left and right extender brackets 11L, 11R, the modular extension plate assembly 2 has a width Z about the same as the vehicle bed width X. FIG. 9 also illustrates the liftgate mounting members 13-4 coupled to the bottom of the vehicle bed 12.

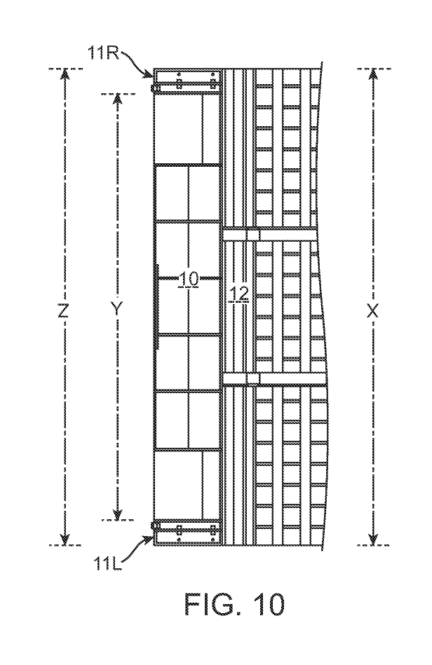

FIG. 10 illustrates a bottom view of the modular extension plate assembly 2 coupled to the rear edge 13 of the vehicle bed 12 (corresponding to FIGS. 7-9), according to an embodiment of the present invention. This view further illustrates how the width Y of the extension plate 10 alone is less than the vehicle bed width X. Yet, by employing the left and right extender brackets 11L, 11R, the modular extension plate assembly 2 has a width Z about equal to the vehicle bed width X.

According to embodiments of the invention, more than one extender bracket 11 may be coupled to each side of the extension plate 10 as needed to match the width of a vehicle bed. Alternatively, an embodiment of the present invention allows the modular extension plate kit 1 to employ a single extender bracket 11 at one end of the extension plate 10. Further configurations of the modular extension plate kit 1 include employing three extender brackets with two brackets on one side of the extension plate 10 and a single bracket on the opposite side. Moreover, two extender brackets may reside on a single side of the extension plate 10 without any extender brackets residing on the opposite side of said plate 10. Those skilled in the art appreciate that any combination of extender brackets and the extension plate 10 may be utilized to ensure the assembly 2 has a width Z about equal to the vehicle bed width X.

FIG. 11 illustrates a front perspective view of a modular extension plate assembly 2, according to an embodiment of the present invention. The modular extension plate assembly 2 comprises a first and second left extender bracket 11L, 11LB, coupled in tandem and coupled to one side of the extension plate 10. Further, a first and second right extender bracket 11R, 11RB, are coupled in tandem and coupled to the opposite side of the extension plate 10. As noted, the extension plate 10 is an elongated rectangular plate having an essentially L-shaped profile. In an embodiment of the invention as depicted in FIG. 11, the modular extension plate assembly 2 further comprises the front member 10F for displaying vehicle information (e.g., license plate).

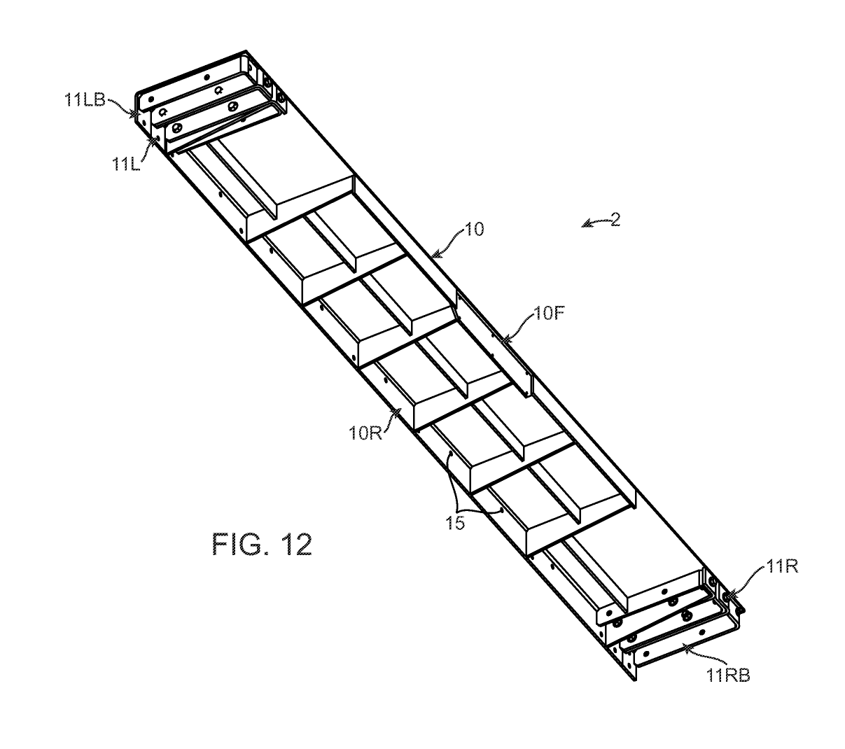

FIG. 12 illustrates a bottom perspective view of a modular extension plate assembly 2 (corresponding to FIG. 11), according to an embodiment of the present invention. The modular extension plate assembly 2 in FIG. 12 comprises a first and second left extender bracket 11L, 11LB, coupled in tandem and coupled to one side of the extension plate 10, along with a first and second right extender bracket 11R, 11RB, coupled in tandem and coupled to the opposite side of the extension plate 10.

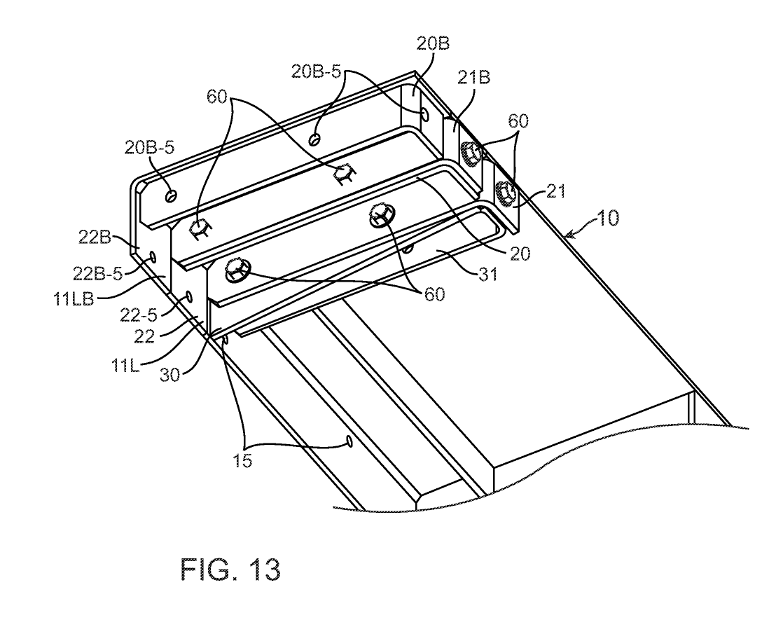

FIG. 13 illustrates a detailed partial bottom perspective view of the first left extender bracket 11L and the second left extender bracket 11LB, corresponding to FIG. 12. In the example shown in FIG. 13, the second left extender bracket 11LB is coupled to the first left extender bracket 11L (e.g., via mounting hardware 60), and the first left extender bracket 11L further coupled to the extension plate 10 (e.g., via mounting hardware 60).

The innermost L-shaped support element 21B of the second left extender bracket 11LB is coupled (e.g., bolted using mounting hardware 60) to the outermost L-shaped support element 20 of the first left extender bracket 11L. The innermost L-shaped support element 21 of the first left extender bracket 11L is further coupled to the triangle-shaped support member 30 and L-shaped support member 31 of the extension plate 10 (e.g., bolted using mounting hardware 60). The extension plate 10, the L-shaped extender plate 22 of the extender bracket 11L, and the L-shaped extender plate 22B of the extender bracket 11LB, can be coupled to the rear edge 13 of a vehicle bed 12 (FIG. 6), utilizing apertures 15, 22-5, and 22B-5. A similar configuration is used to couple the second right extender bracket 11RB to the first right extender bracket 11R, and the first right extender bracket 11R to the extension plate 10.

The example configuration of the assembly 2 shown in FIGS. 11-13 extends the depth of a vehicle bed 12 by the depth D of the extension plate 10. Further, this configuration extends the width of the extension plate 10 by 4E (FIG. 11) corresponding to the combined width of the four extender brackets (11LB, 11L, 11RB, 11R), such that the width of the assembly 2 as shown in FIGS. 11-13 is Z=Y+4E.

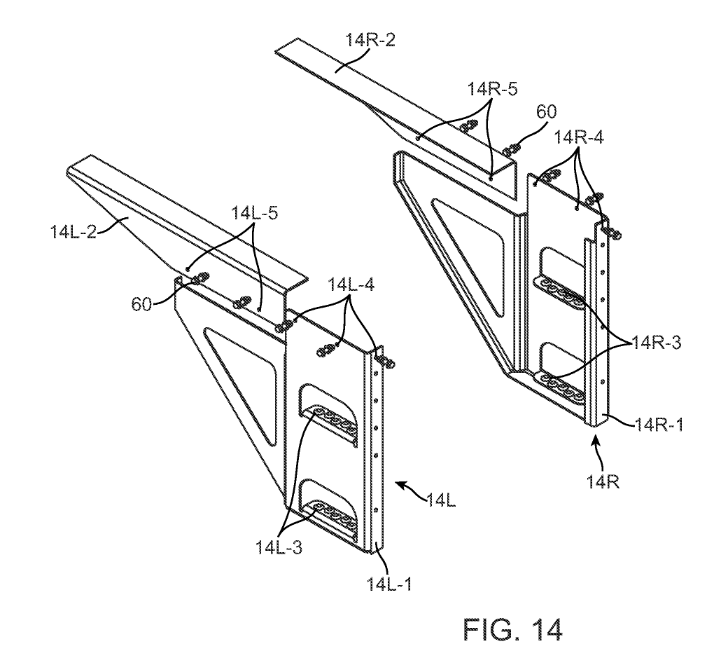

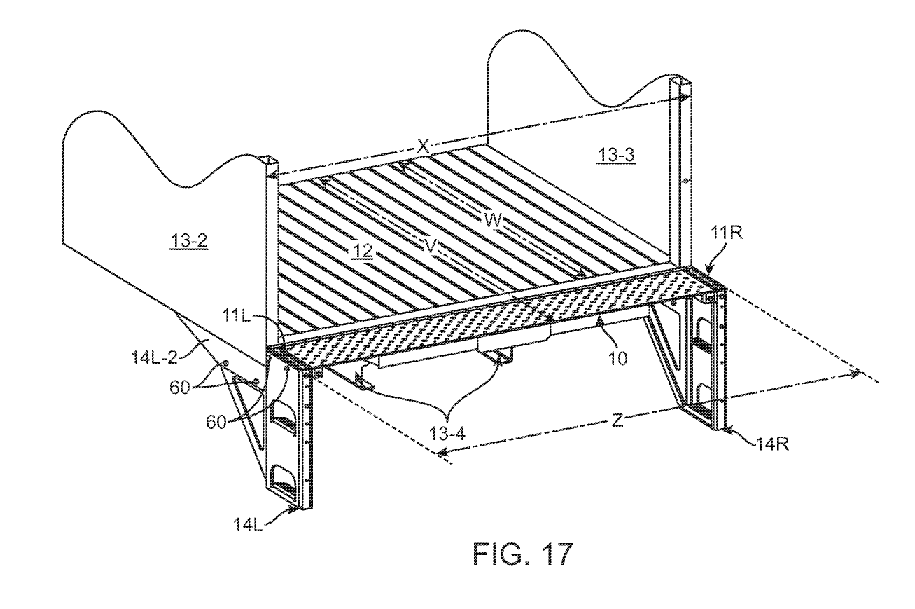

FIG. 14 illustrates a perspective view of a left 14L and a right 14R step system, according to an embodiment of the present invention. The step systems 14L and 14R allow personnel to climb up to the vehicle bed 12 and/or the extension plate assembly 2. The left step system 14L comprises a step frame 14L-1 further comprising two step platforms 14L-3 and three apertures 14L-4. In one embodiment of the present invention, the system 14L comprises a left anchor 14L-2 for coupling (e.g., bolting, welding, etc.) the left step system 14L to the vehicle bed 12 (FIG. 17). The anchor 14L-2 further comprises apertures 14L-5 for removably coupling (i.e. bolting with mounting hardware 60) the anchor to the vehicle bed 12 (FIG. 17). Both the anchor 14L-2 and the step frame 14L-1 utilize standardized mounting hardware 60 for coupling. The right step system 14R and the left step system 14L are similar in dimensions and construction and are essentially mirror images of one another.

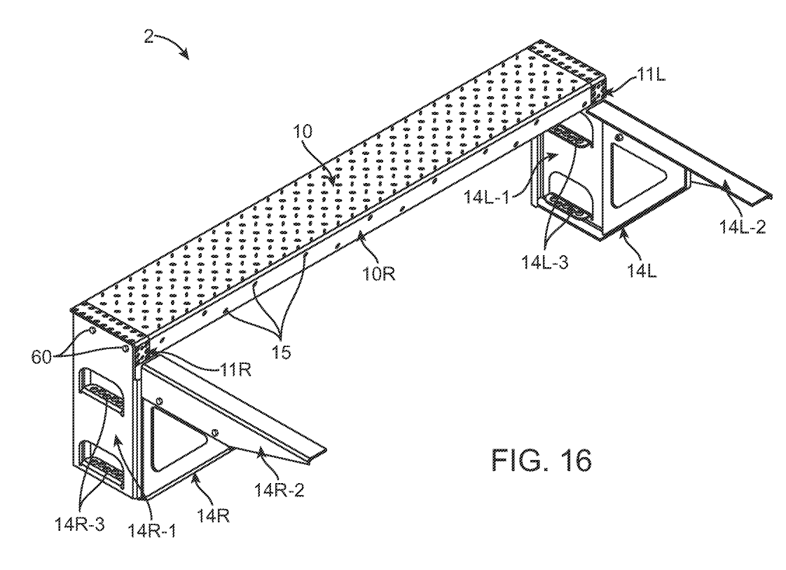

FIG. 15 illustrates a perspective view of the left 114L and right 14R step system coupled to the extension plate assembly 2, according to an embodiment of the present invention. FIG. 16 illustrates a rear perspective view of the left 14L and right 14R step system coupled to the modular extension assembly 2, according to an embodiment of the present invention. In FIGS. 15-16, the left step system 14L is coupled to a left extender bracket 11L of the modular liftgate extension assembly 2. Specifically, the left step frame 14L-1 is coupled (e.g., bolted via mounting hardware 60) to the outermost L-shaped support element of the left extender bracket 11L (FIG. 15). In FIG. 16, the right step system 14R is coupled to a right extender bracket 11R of the modular liftgate extension assembly 2. Specifically, the right step frame 14R-1 is coupled (e.g., bolted via mounting hardware 60) to the outermost L-shaped support element of the right extender bracket 11R. Since multiple extender brackets 11L, 11R, 11LB, and 11RB (FIGS. 11-13) are utilized in certain embodiments of the present invention, it is understood that the right step systems 14L and 14R can be utilized in conjunction similarly with the outermost extender brackets 11LB, 11RB.

FIG. 17 illustrates a perspective view of the modular extension plate assembly 2 utilizing the left 14L and right 14R step system and coupled to the rear edge 13 of the vehicle bed 12, according to an embodiment of the present invention. In this figure, the left step system 14L couples to the left extender bracket 11L while the right step system 14R couples to the right extender bracket 11R. The extender brackets 11L and 11R are further coupled to the extension plate 10. The extension plate assembly 2 comprising the extension plate 10, the left extender bracket 11L, and right extender bracket 11R is coupled to the rear edge of a vehicle bed 12. The step systems 14L and 14R allow an operator the ability to climb up to/down from the vehicle bed 12 and/or the extension plate 10. The left 14L and right 14R step systems hang primarily below the left and right extender brackets 11L, 11R, respectively. Therefore, the step systems do not affect the width Z of the modular extension plate kit 1. When installed, the left step system 14L does not protrude laterally farther than the left wall 13-2 of the vehicle. Similarly, the right step system 14R does not extend laterally beyond the right wall 13-3 of the vehicle. Also depicted in FIG. 17, the left and right step systems 14L, 14R, do not interfere with the liftgate mounting members 13-4 coupled underneath the vehicle bed 12.

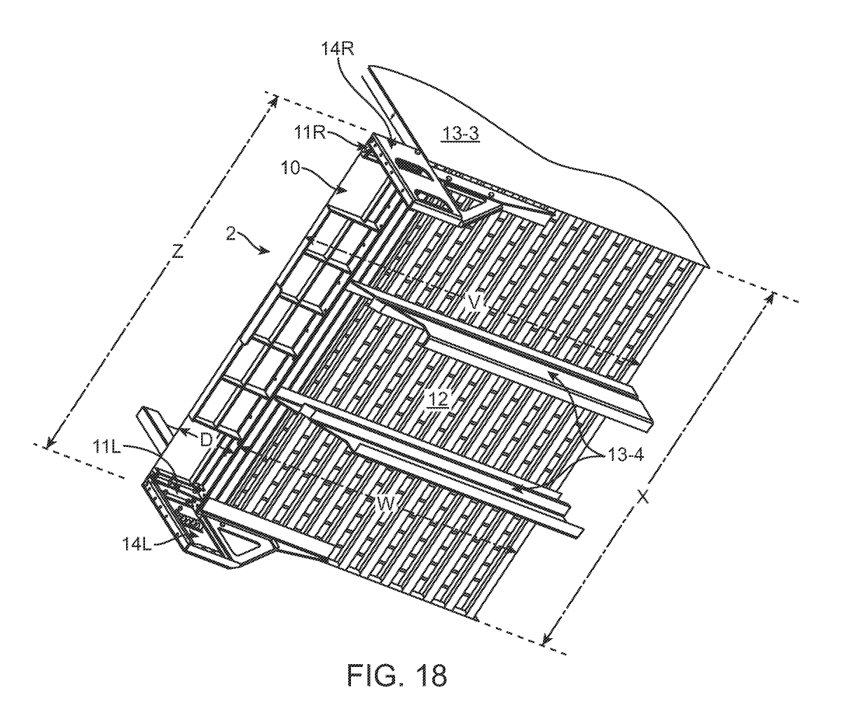

FIG. 18 illustrates a bottom perspective view of the modular extension plate assembly 2 of FIG. 17, comprising the left 14L and right 14R step system, according to an embodiment of the present invention. In this figure, it is apparent the right step system 14R does not extend laterally beyond the right wall 13-3 of the vehicle. Also apparent in FIG. 18 is the evidence that the left and right step systems 14L, 14R do not interfere with the liftgate mounting members 13-4 coupled to the bottom of the vehicle bed 12. When the modular extension plate kit 1 is coupled to the rear edge of the vehicle bed 12, the depth V of the vehicle bed 12 and assembly 2 is greater than the depth W of the bed 12 alone; where V=W+D.

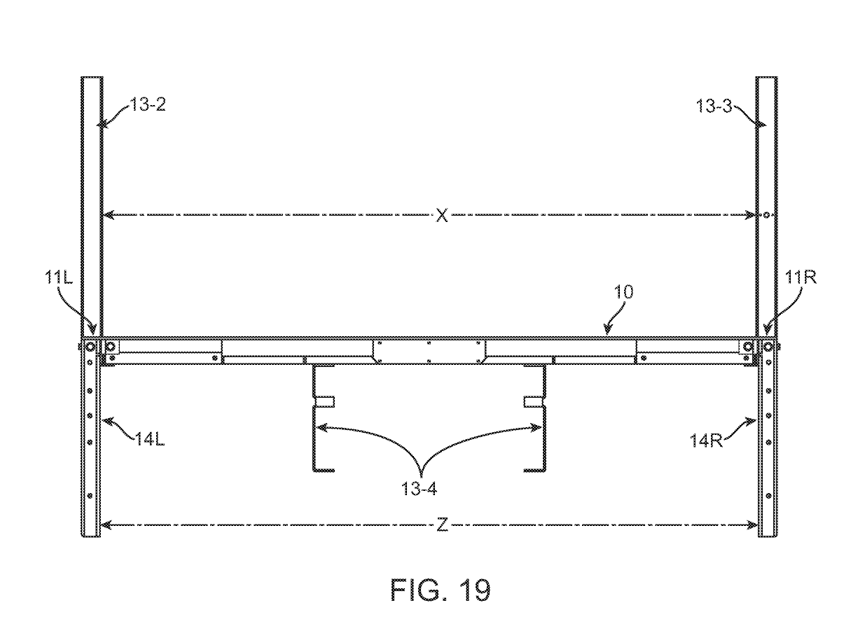

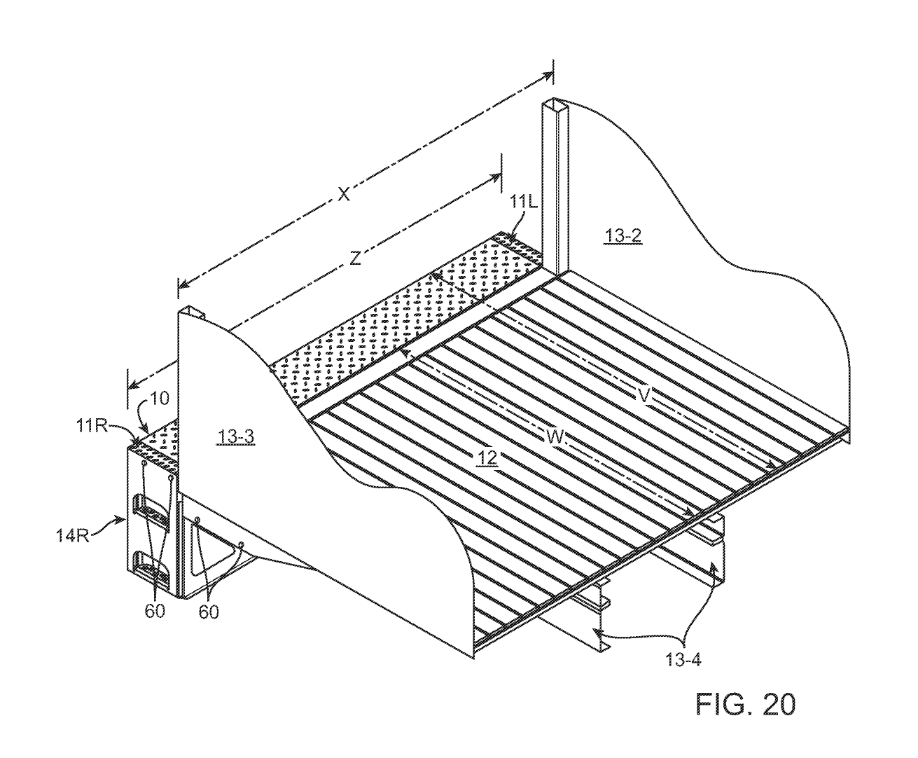

FIG. 19 illustrates a rear view of the modular extension plate assembly 2 of FIG. 18, comprising the left 14L and right 14R step system, according to an embodiment of the present invention. FIG. 20 illustrates a rear perspective view of the modular extension plate assembly 2 of FIG. 19, comprising the left 14L and right 14R step system, according to an embodiment of the present invention. It is apparent that both the left and right step systems 14L, 14R, hang perpendicular to the extension plate 10, and do not extend laterally beyond the left and right walls 13-2, 13-3, of the vehicle (FIG. 19). As such, the modular extension plate assembly 2 utilizing the left and right step systems 14L, 14R, has a width Z approximately the same as the vehicle bed 12 width X. Also noted in FIG. 19, the left and right step systems 14L, 14R, do not interfere with the liftgate mounting members 13-4 coupled to the bottom of the vehicle bed 12.

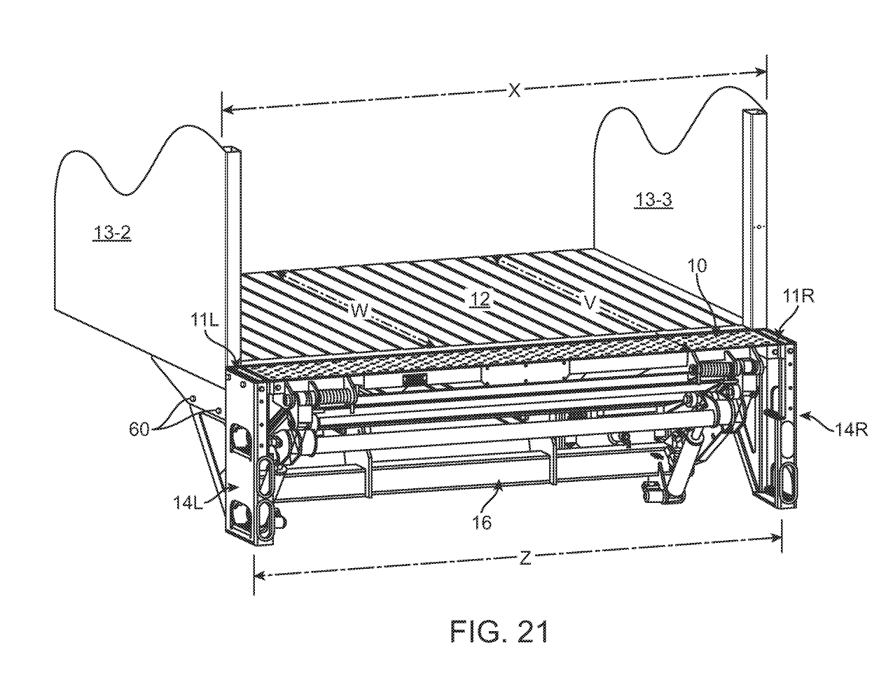

FIG. 21 illustrates a perspective view of the modular extension plate assembly 2 of FIG. 20, comprising the left 14L and right 14R step system and coupled to the rear edge of the vehicle, the vehicle having a liftgate 16 coupled thereto, according to an embodiment of the present invention. In this figure, the left step system 14L couples to the left extender bracket 11L and the right step system 14R couples to the right extender bracket 11R. The extender brackets 11L and 11R in turn are coupled to the extension plate 10. The extension plate assembly 2 is further coupled to the rear edge of a vehicle bed 12. The extension plate assembly 2, when employing the step systems 14L, 14R, is wider than the liftgate 16; therefore the step systems 14L, 14R, do not interfere with the liftgate 16 coupled to the bottom of the vehicle bed 12. In this configuration, the liftgate 16 may extend and retract without interference from the step systems 14L, 14R. One embodiment of the liftgate 16 comprises a platform coupled to a support frame via a lift linkage, the platform capable of being moved by an actuator via the lift linkage between a raised position and a lowered position. When fully raised (not depicted), the platform abuts the forward edge of the extension plate 10 to further extend the depth of the vehicle bed 12. Also, when the platform is fully raised, it is parallel to both the vehicle bed 12 and the modular extension plate assembly 2.

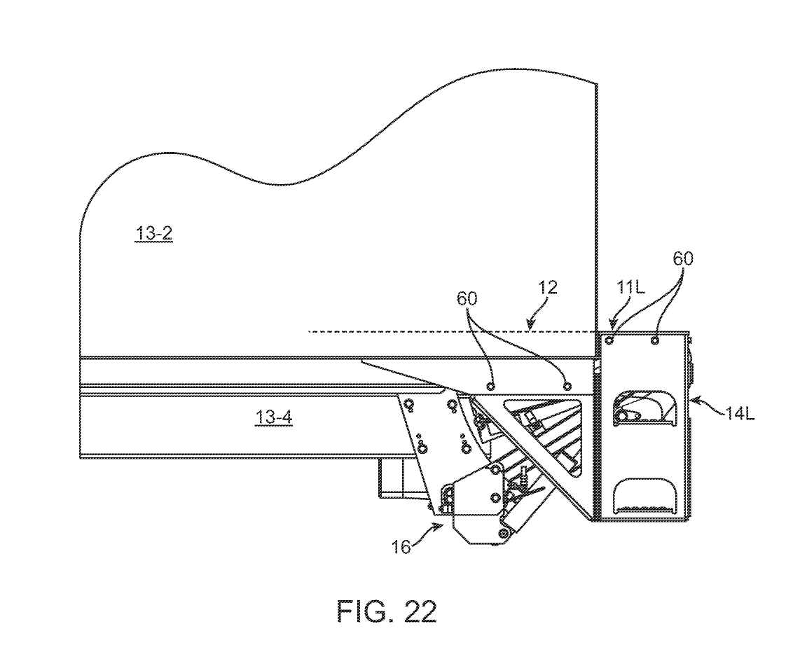

FIG. 22 illustrates a side view of the modular extension plate assembly 2 of FIG. 21, comprising the left step system, 14L, and coupled to the rear edge of the vehicle 12, the vehicle having a liftgate 16 coupled thereto, according to an embodiment of the present invention. As depicted, the liftgate 16 couples to the bottom of the vehicle bed 12 utilizing liftgate mounting members 13-4 coupled to the bottom of the vehicle bed 12.

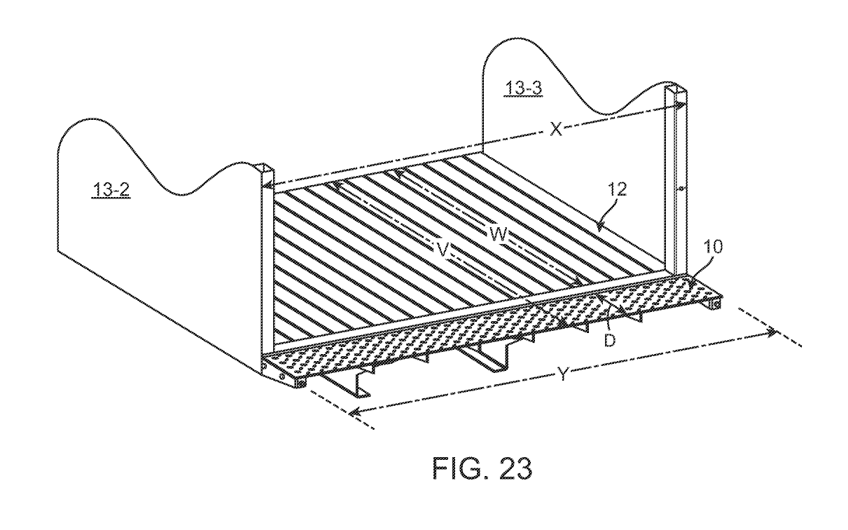

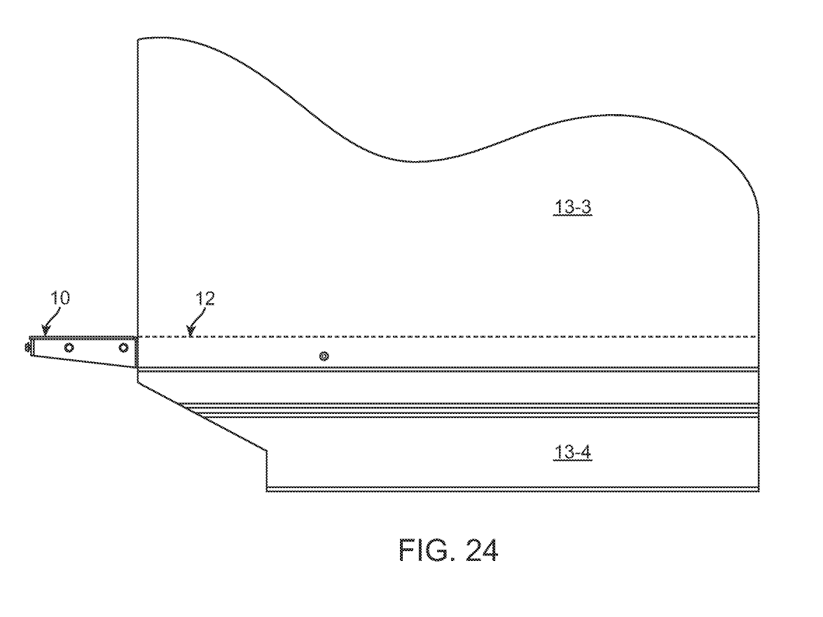

FIG. 23 illustrates a perspective view of an extension plate 10 coupled to the rear edge of the vehicle 12, without extender brackets 11, according to an embodiment of the present invention. FIG. 24 illustrates a side view of the extension plate 10 coupled to the rear edge of a vehicle 12, according to an embodiment of the present invention. The extender brackets 11L, 11R, are not utilized in this configuration since the width Y of the extension plate 10 closely matches the width X of the vehicle bed 12 (FIG. 23). In FIG. 23, the vehicle comprises a bed 12, a left wall 13-2, and a right wall 13-3. The vehicle bed 12 has a width X which is the distance between the left and right walls 13-2, 13-3. The vehicle bed 12 also has a depth W which is the distance between the front and rear of the bed. The extension plate 10 has a width Y which equals the width X of the vehicle bed 12. When the extension plate 10 is coupled to the rear edge of the vehicle bed 12, the depth V of the vehicle bed 12 and plate 10 is greater than the depth W of the bed 12 alone/V=W+D (FIG. 23). As depicted in FIG. 24, the extension plate 10 parallel to with the vehicle bed 12 when coupled thereto.

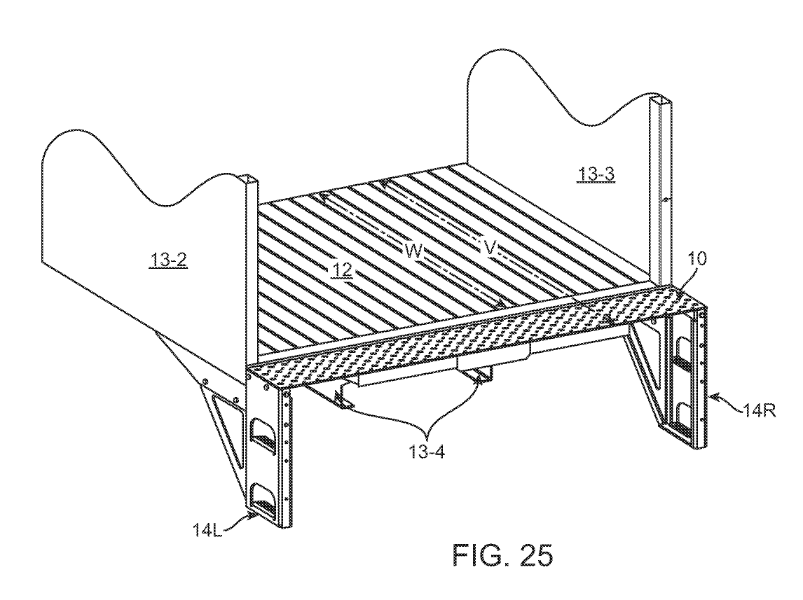

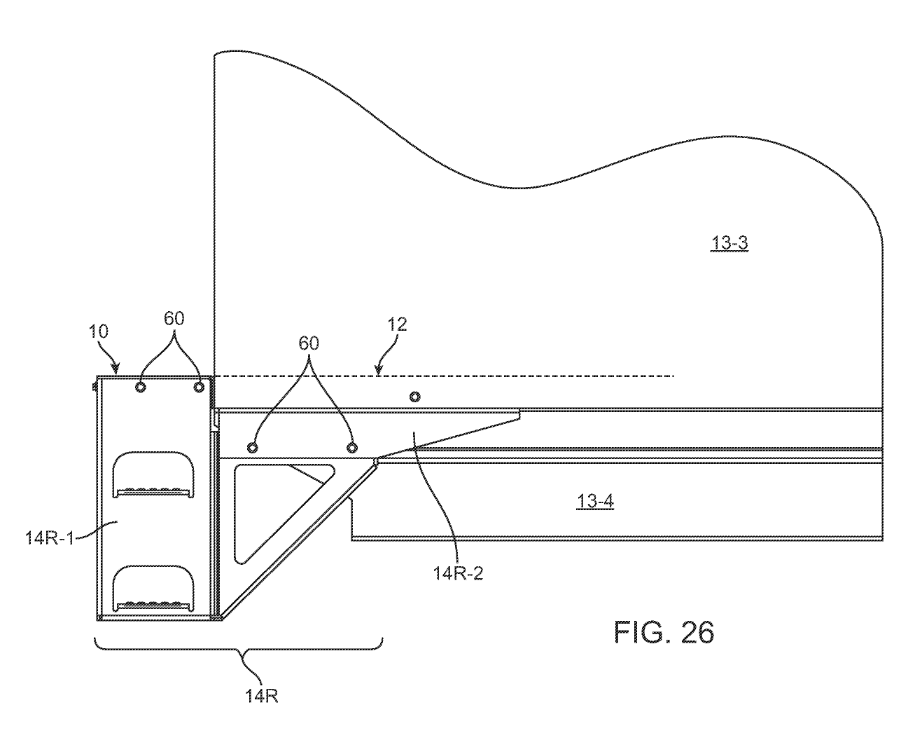

FIG. 25 illustrates a perspective view of the left 14L and right 14R step systems directly coupled to the extension plate 10 (without extender brackets 11), wherein the extension plate 10 is further coupled to the rear edge of a vehicle 12, according to an embodiment of the present invention. FIG. 26 illustrates a side view of the right step system 14R directly coupled to the extension plate 10, the plate 10 further coupled to the rear edge of a vehicle 12, according to an embodiment of the present invention. The left 14L and right 14R step systems primarily hang below the extension plate 10 (FIG. 25) so as not to affect function of a liftgate that may be coupled to the liftgate mounting members 13-4 underneath the vehicle bed 12. When installed, the left step system 14L does not protrude laterally farther than the left wall 13-2 of the vehicle (FIG. 25). Similarly, the right step system 14R does not extend laterally beyond the right wall 13-3 of the vehicle.

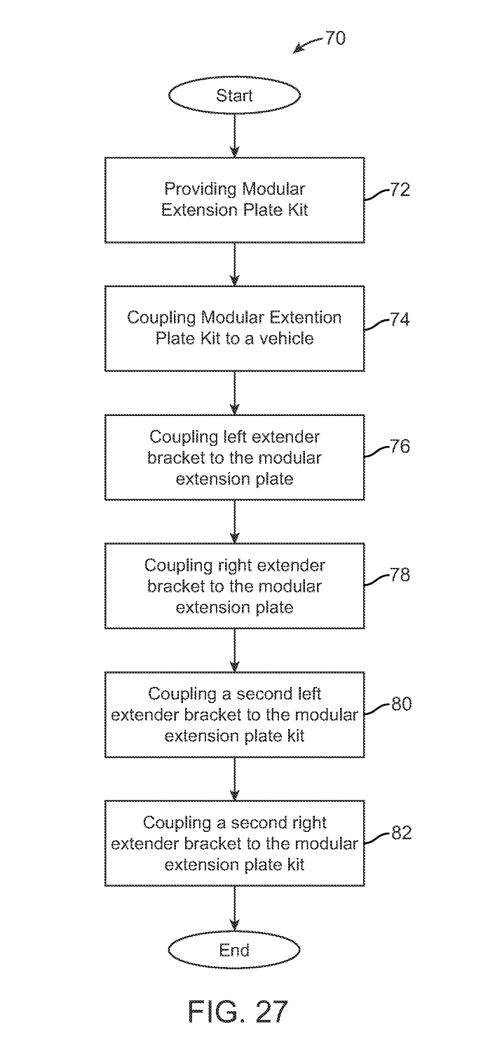

FIG. 27 illustrates a method 70 for assembling and mounting the modular extension plate kit 1 to the rear edge 13 of a vehicle 12 (FIG. 7), according to an embodiment of the present invention. The method 70 begins with step 72 which comprises providing the modular extension plate kit 1. In this embodiment of the present invention, the modular extension plate kit 1 comprises an extension plate 10, and one or more extension plates 11 (e.g., left extender bracket 11L, and a right extender bracket 11R (FIG. 1B)). Next, the method 70 continues with step 74 which comprises coupling (e.g., welding, bolting, etc.) the extension plate 10 to the rear edge 13 of the vehicle 12. If the width of the extension plate 10 is less than the vehicle bed width, then one or more extender brackets 11 can be coupled to the extension plate 10, such as in steps 76 and 78 which involve coupling the left and right extender brackets 11L, 11R, to the extension plate 10 (FIG. 3).

Step 76 entails coupling the left extender bracket 11L to the extension plate 10 by bolting the innermost support element 21 to both the triangle-shaped support member 30 and the L-shaped support member 31 (FIG. 4). Step 78 entails coupling the right extender bracket 11R to the extension plate 10 by bolting the innermost support element 41 to both the triangle-shaped support member 50 and the L-shaped support member 51 (FIG. 5) is performed.

Additional extender brackets 11 may be assembled in tandem to provide an extension plate assembly that essentially matches the width of the vehicle bed. In that case, steps 82 and 82 involve coupling second left and right extender brackets 11LB, 11RB, to the modular extension plate assembly 2.

Coupling the second left extender bracket 11LB to the first left extender bracket 11L, as per step 80, entails coupling the innermost L-shaped support element 21B of the second left extender bracket 11LB to the outermost L-shaped support element 20A of the first left extender bracket 11L (FIG. 13). The innermost L-shaped support element 21A of the first left extender bracket 11L is further coupled to the triangle-shaped support member 30 and L-shaped support member 31 of the extension plate 10 (e.g., bolted using mounting hardware 60) (FIG. 13). A similar method is used in step 82 for coupling the second right extender bracket 11RB to the first right extender bracket 11R, and the first right extender bracket 11R to the extension plate 10 (FIG. 12). After completion of step 82, the method 70 ends.

The extension plate 10 and, as needed, one or more brackets 11 may be assembled to each other and coupled to the vehicle in any other. For example, in another embodiment of an assembly method according to the invention, the modular extension plate kit 1 (FIG. 1A) can be assembled into the extension plate assembly 2 first, and then the extension plate assembly 2 is coupled to the end of the vehicle bed.

The vehicle bed 12 (FIG. 25) can be of varying widths such as approximately ninety-six inches (96″), one hundred and two inches (102″), etc. The extension plate 10 (FIG. 1B) can also be of varying widths such as ninety-six inches (96″), one hundred and two inches (102″), etc.

Further, the extender brackets 11L and 11R (FIG. 17) can be of varying widths such as one inch (1″), two inches (2″), three inches (3″), etc. For example, if a given vehicle bed 12 (FIG. 25) has a width of 102″; a modular extension plate kit 1 may comprise a 96″ extension plate 10 and two 3″ extender brackets 11L and 11R. Alternatively, the modular extension plate kit 1 may comprise two 3″ left extender brackets 11L and 11LB. Another example may include a 96″ extension plate 10 and three 2″ extender brackets. Another example may include five 1″ extender brackets and a 96″ extension plate 10. It is understood that any combination of extender brackets and extension plate may be utilized to match the width of a given vehicle bed. The modular extension plate kit 1 (FIG. 1B) may also be made of rigid materials such as metal.

The present invention has been described in considerable detail with reference to certain preferred versions thereof; however, other versions are possible. Therefore, the spirit and scope of the appended claims should not be limited to the description of the preferred versions contained herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A modular extension device for a vehicle bed, comprising:
an elongated rectangular extension plate member having a width and a depth; and
one or more extender members, each extender member configured for coupling to one end of the extension plate member;
wherein the extender members and the extension plate member are arranged in tandem alignment to form an extension assembly essentially matching a width of a vehicle bed; and
wherein upon mounting the extension assembly adjacent to the vehicle bed, the modular extension assembly extends depth of the vehicle bed by the amount of depth of the extension plate member.

2. The device of claim 1, further comprising:
a first extender member configured for coupling to an end of the extension plate member; and
a second extender member configured for coupling to an opposite end of the extension plate member;
wherein the extender members extend the width of the extension plate member for matching the width of the vehicle bed.

3. The device of claim 2, further comprising:
a third extender member further configured for coupling to said first extender member of the extension assembly in tandem for further extending the width of the extension assembly to essentially match the width of the vehicle bed.

4. The device of claim 3, further comprising:
a fourth extender member configured for coupling to said second extender member of the extension assembly in tandem for further extending the width of the extension assembly to essentially match the width of the vehicle bed.

5. The device of claim 1, wherein:
each extender member is of the same depth as the depth of the extension plate member and of narrower width than the width of the extension plate member; and
a combined width of the extension plate member and each extender member is greater than the width of the extension plate member.

6. The device of claim 5, wherein the extension plate member further comprises:
a first support element; and
a second support element;
wherein the first support element is coupled to one end of an underside of the extension plate member;
wherein the second support member is coupled to an opposite end and underside of the extension plate member.

7. The device of claim 6, wherein the extension plate member further comprises:
a third support element; and
a fourth support element;
wherein the third support element is couple to the underside of the extension plate member between the first and second support elements and adjacent the first support element;
wherein the fourth support element is coupled to the underside of the extension plate member between the first and second support elements and adjacent the second support element.

8. The device of claim 7, wherein:
the first and second support elements are each substantially triangle-shaped; and
the third and four support elements are each essentially L-shaped.

9. The device of claim 8, wherein the first extender member comprises:
a first wall, a second wall, and a third wall;
the first wall and second wall each having a width and depth, the depth being the same depth as the extension plate member;
the third wall having a long segment and a short segment coupled at traverse angles;
wherein the first wall is coupled to an edge of both segments of the third wall and in a plane perpendicular to both segments of the third wall; and
wherein the second wall is coupled to an edge of both segments of the third wall, the second wall in a plane parallel to the first wall and perpendicular to both the first and second segments of the third wall.

10. The device of claim 9, wherein the second extender member comprises:
a first wall, a second wall, and a third wall;
the first wall and second wall each having a width and depth, the depth being the same depth as the extension plate member;
the third wall having a long segment and a short segment coupled at traverse angles;
wherein the first wall is coupled to an edge of both segments of the third wall and in a plane perpendicular to both segments of the third wall; and
wherein the second wall is coupled to an edge of both segments of the third wall, the second wall in a plane parallel to the first wall and perpendicular to both the first and second segments of the third wall.

11. The device of claim 1, wherein:
the first extender member is coupled to an end of the extension plate member in the extension assembly; and
the second extender member is coupled to the opposite end of the extension plate member in the extension assembly.

12. The device of claim 11, wherein:
a third extender member is coupled to said first extender member in tandem for further extending the width of the extension assembly to essentially match the width of the vehicle bed.

13. The device of claim 11, further comprising:
a first step system configured for coupling to the first extender member; and
a second step system configured for coupling to the second extender member;
the first and second step system providing means for climbing onto the extension assembly.

14. The device of claim 13, wherein:
the extension plate member and the extender members of the extension assembly are directly coupled to a rear edge of the vehicle bed.

15. A modular extension device for a vehicle bed, comprising:
an elongated rectangular extension plate member having a width and a depth forming an extension assembly essentially matching the width of a vehicle bed; and
wherein upon mounting the extension assembly directly adjacent to a rear edge of the vehicle bed, the modular extension device extends depth of the vehicle bed by the amount of depth of the extension plate member.

16. The device of claim 15, further comprising:
a first step system configured for coupling to an end of the extension plate member of the extension assembly; and
a second step system configured for coupling to an opposite end of the extension plate member of the extension assembly;
the first and second step system providing means for climbing onto the extension assembly.

17. The device of claim 16, wherein the first step system comprises:
a step frame having a width and height, the width being equal to the depth of the extension plate member;
an anchor member coupled to the step frame and configured for coupling to an underside of the vehicle bed; and
at least one step platform providing means for climbing onto the extension assembly.

18. The device of claim 17, wherein the second step system comprises:
a step frame having a width and height, the width being equal to the depth of the extension plate member;
an anchor member coupled to the step frame and configured for coupling to an underside of the vehicle bed; and
at least one step platform providing means for climbing onto the extension assembly.

19. The device of claim 18, wherein:
the first step system this coupled to an end of the extension plate member in the extension assembly; and
the second step system is coupled to the opposite end of the extension plate member in the extension assembly.

20. The device of claim 19, wherein:
the extension assembly is directly coupled to the rear edge of the vehicle bed.

21. A modular extension device for a vehicle bed, comprising:
an elongated rectangular extension plate member having a width and a depth; and
one or more extender members, each extender member coupled to one end of the extension plate member;
wherein the extender members and the extension plate member are arranged in tandem alignment to form an extension assembly essentially matching a width of a vehicle bed;
wherein upon mounting the extension assembly adjacent to the vehicle bed, the modular extension assembly extends depth of the vehicle bed by the amount of depth of the extension plate member.

22. The device of claim 21, further comprising:
a first extender member coupled to an end of the extension plate member; and
a second extender member coupled to an opposite end of the extension plate member;
wherein the extender members extend the width of the extension plate member for matching the width of the vehicle bed.

23. The device of claim 22, further comprising:
a third extender member coupled to said first extender member of the extension assembly in tandem for further extending the width of the extension assembly to essentially match the width of the vehicle bed.

24. A method for extending depth of a vehicle bed, comprising:
providing a modular extension device (1), comprising:
an elongated rectangular extension plate member having a width and a depth; and
one or more extender members, each extender member configured for coupling to one end of the extension plate member, wherein the extender members and the extension plate member are arranged in tandem alignment to form an extension assembly essentially matching the width of a vehicle bed; and
coupling the modular extension assembly to a rear edge of the vehicle bed, wherein the modular extension assembly extends depth of the vehicle bed by the amount of depth of the extension plate member.

25. The method of claim 24, further comprising:
coupling a first extender member to an end of the extension plate member; and
coupling a second extender member to an opposite end of the extension plate member;
wherein the extender members extend the width of the extension plate member for matching the width of the vehicle bed.

26. The method of claim 25, further comprising:
coupling an extender member to said first extender member of the extension assembly in tandem for further extending the width of the extension assembly to essentially match the width of the vehicle bed.

27. The method of claim 26, further comprising:
coupling an extender member to said second extender member of the extension assembly in tandem for further extending the width of the extension assembly to essentially match the width of the vehicle bed.

28. The method of claim 27, wherein:
each extender member is of the same depth as the extension plate member and of narrower width than the extension plate member; and
a combined width of the extension plate member and each extender member is greater than the width of the extension plate member.

29. A modular extension device for a vehicle bed, comprising:
an elongated rectangular extension plate member having a width and a depth;
one or more extender members, each extender member configured for coupling to one end of the extension plate member, wherein the extender members and the extension plate member are arranged in tandem alignment to form an extension assembly essentially matching width of a vehicle bed;
a first extender member configured for coupling to an end of the extension plate member;
a second extender member configured for coupling to an opposite end of the extension plate member;
a first step system configured for coupling to the first extender member; and
a second step system configured for coupling to the second extender member;
the step systems providing means for climbing onto the extension plate member;
wherein upon mounting the extension assembly adjacent to the vehicle bed, the modular extension assembly extends depth of the vehicle bed by the amount of depth of the extension plate member; and
wherein each extender member is of the same depth as the extension plate member and of narrower width than the extension plate member.

30. The modular extension device of claim 29, wherein:
the extension plate member further comprises:
a first support element;
a second support element;
a third support element; and
a fourth support element;
the first support element is coupled to one end of an underside of the extension plate member;
the second support member is coupled to an opposite end and underside of the extension plate member;
the third support element is couple to the underside of the extension plate member between the first and second support elements and adjacent the first support element;
the fourth support element is coupled to the underside of the extension plate member between the first and second support elements and adjacent the second support element.
the first and second support elements are each substantially triangle-shaped;
the third and four support elements are each essentially L-shaped;
the first extender member comprises:
a first wall a second wall, and a third wall;
the first wall and second wall each having a width and depth, the depth being the same depth as the extension plate member;
the third wall having a long segment and a short segment coupled at traverse angles;
the first wall is coupled to an edge of both segments of the third wall and in a plane perpendicular to both segments of the third wall;
the second wall is coupled to an edge of both segments of the third wall, the second wall in a plane parallel to the first wall and perpendicular to both the first and second segments of the third wall.

31. The modular extension device of claim 30, wherein:
the second extender member comprises:
a first wall a second wall, and a third wall;
the first wall and second wall each having a width and depth, the depth being the same depth as the extension plate member;
the third wall having a long segment and a short segment coupled at traverse angles;
the first wall is coupled to an edge of both segments of the third wall and in a plane perpendicular to both segments of the third wall;
the second wall is coupled to an edge of both segments of the third wall, the second wall in a plane parallel to the first wall and perpendicular to both the first and second segments of the third wall;
the first extender member is coupled to an end of the extension plate member in the extension assembly;
the second extender member is coupled to the opposite end of the extension plate member in the extension assembly; and
a third extender member is coupled to said first extender member in tandem for further extending the width of the extension assembly to essentially match the width of the vehicle bed;
wherein the extension plate member and the extender members of the extension assembly are directly coupled to a rear edge of the vehicle bed; and
wherein a combined width of the extension plate member and each extender member is greater than the width of the extension plate member.
